(19) United States
(12) Patent Application Publication
(10) Pub. No.: US 2020/0370744 A1
(43) Pub. Date: Nov. 26, 2020

(54) FULLY ENCAPSULATING LIGHTING TECHNOLOGY

(71) Applicant: Crystal Fountains Holdings Inc., Concord (CA)

(72) Inventors: Alessandro Rama, Toronto (CA); George Ayer, Etobicoke (CA); Mirush Trimi, Etobicoke (CA); David Barratt, Hastings (CA); Piyush Kumar Munjal, Brampton (CA)

(21) Appl. No.: 16/636,723

(22) PCT Filed: Aug. 9, 2018
(86) PCT No.: PCT/CA2018/050967

§ 371 Date: Feb. 5, 2020

Related U.S. Application Data
(60) Provisional application No. 62/544,225, filed on Aug. 11, 2017.

(51) Int. Cl. F21V 31/00; F21V 7/00; F21V 29/70; F21V 33/00; B05B 17/08

(52) U.S. Cl. CPC F21V 31/005; F21V 7/0083; F21W 2121/02; F21V 33/006; B05B 17/08; F21V 29/70

(57) ABSTRACT

A water resistant lighting device is provided. The water resistant lighting device comprises an external lens, a light source, and at least one reflective surface. The water resistant lighting device also comprises a water-resistant material filling at least some of the space between the light source and the external lens, as well as filling at least some of the space between the reflective surface and the external lens. This water-resistant material may be a relatively soft gel, softer than an LED that may provide the light source, as well as softer than the LED circuit board. This water-resistant soft gel may protect the LED and the LED circuit board from water leakage. This water-resistant soft gel may also cushion these components from expansion and compression due, for example, to temperature changes.

### FIELD OF THE INVENTION

This invention relates generally to water resistant lighting devices. More particularly, it relates to a water resistant lighting device incorporating a water-resistant material to impede leakage.

### BACKGROUND OF THE INVENTION

Lights in water-rich environments face the problem of leakage. For example, water may be prone to leak into lights located underwater, or lights subjected to high levels of precipitation. The presence of water within the light may distort the light emitted, and also damage circuitry and other components of the light. A water resistant lighting device that addresses these problems is therefore desirable.

### SUMMARY OF THE INVENTION

In accordance with an aspect of the present invention, there is provided a water resistant lighting device that may have: an external lens; at least one light source for directing light toward the external lens; at least one water-resistant material for isolating the at least one light source from water, the at least one water-resistant material constituting a water barrier for isolating the at least one light source from water, the water barrier having a proximal surface facing the at least one light source, and a distal surface facing the external lens, wherein relative positions and orientations of the external lens and the at least one light source are substantially fixed, and light projected from the at least one light source toward the external lens passes through the water barrier and at least one direct volume extending from the at least one light source to the external lens and intersecting with the water barrier, such that the water barrier impedes leakage of water adjacent the distal surface to the at least one light source, occupies most of the at least one direct volume, and transmits the light projected from the at least one light source to the external lens; at least one reflective surface for reflecting light from the at least one light source toward the external lens, the water barrier may impede leakage of water adjacent the distal surface to the at least one reflective surface, the position and orientation of the at least one reflective surface may be substantially fixed relative to the positions and orientations of the external lens and the at least one light source, light reflected from the at least one reflective surface toward the external lens may pass through at least one reflected volume extending from the at least one reflective surface to the external lens and may intersect with the water barrier such that the water barrier may occupy most of the at least one reflected volume, impede leakage of water adjacent the distal surface to the at least one reflective surface, and transmit the light reflected from the at least one reflective surface to the external lens.

In another embodiment, the water resistant lighting device may have a housing defining an opening; an external lens for covering the opening of the housing, the external lens may be attached to the housing, and may have an internal surface and an opposing external surface, the housing and the internal surface of the external lens may define an interior cavity of the housing; at least one light source may be mounted within the interior cavity of the housing; at least one reflective surface for reflecting light from the at least one light source toward the external lens; at least one water-resistant material occupying the interior cavity of the housing, light projected from the at least one light source toward the external lens may pass through at least one direct volume extending from the at least one light source to the external lens and comprising the at least one water-resistant material such that a direct volume refractive index may be substantially constant throughout the at least one direct volume, and light reflected from the at least one reflective surface toward the external lens may pass through at least one reflected volume extending from the at least one reflective surface to the external lens and comprising the at least one water-resistant material such that a reflected volume refractive index may be substantially constant throughout the at least one reflected volume.

In some embodiments, the water resistant lighting device may contain a hardened exterior layer, the hardened exterior layer may be harder than the water barrier, and may provide a housing for containing the water barrier and the at least one light source.

In some embodiments, the hardened exterior layer may be made of the at least one water-resistant material.

In some embodiments, the at least one water resistant material may contain a softer water-resistant material and a harder water-resistant material, the hardened exterior layer being formed of the harder water-resistant material, and the water barrier being formed of the softer water-resistant material.

In some embodiments, the water resistant lighting device may contain a thermally-conductive heat sink for conducting heat from the at least one light source. The thermally conductive heat sink may extend through the at least one water-resistant material.

In some embodiments, the water resistant lighting device may have a housing defining an opening, wherein the external lens covers the opening of the housing, the external lens having an internal surface and an opposing external surface. The housing and the internal surface of the external lens define an interior cavity of the housing and the at least one light source may be mounted within the interior cavity of the housing, the at least one water-resistant material being provided within the interior cavity.

In some embodiments, the external lens may be attached to the distal surface of the water barrier, and may be movable relative to the housing.

In some embodiments a direct volume refractive index may be substantially constant throughout the at least one direct volume. This could, for example, be provided for each direct volume by providing one or more than one water-resistant material throughout the direct volume, such that substantially the entire direct volume is occupied by the at least one water-resistant material. If more than one water-resistant material is included within the direct volume, then these water-resistant materials could be selected to have substantially the same refractive indices, varying by less than 5%.

In some embodiments, a reflected volume refractive index is substantially constant throughout the at least one reflected volume. This could, for example, be provided for each reflected volume by providing one or more than one water-resistant material throughout the reflected volume, such that substantially the entire reflected volume is occupied by the at least one water-resistant material. If more than one water-resistant material is included within the reflected volume, then these water-resistant materials could be selected to have substantially the same refractive indices, varying by less than 5%.

In some embodiments, the at least one water-resistant material may be a solid.

In some embodiments, the at least one water-resistant material may contain constituents selected from the following materials: urethane, polyurethane, silicon, silicone gel, epoxy, acrylic, and polyester.

In some embodiments, the at least one water-resistant material may be a gel. The gel may be a silicon gel. The silicon gel may be a silicone gel.

In some embodiments, the at least one water-resistant material may extend through most of the at least one direct volume, and the at least one water-resistant material may extend through most of the at least one reflected volume. In some embodiments, the at least one water-resistant material may extend through all or almost all the direct volume, and the at least one water-resistant material may extend through all or almost all the at least one reflected volume.

In some embodiments, the at least one water-resistant material may be a substantially uniform water-resistant material. There may be a direct volume refractive index that may be substantially constant throughout the at least one direct volume and a reflected volume refractive index that may be substantially constant throughout the at least one reflected volume. The reflected volume refractive index and the direct volume refractive index may be substantially equal.

In some embodiments, the substantially uniform water-resistant material may have a thermal conductivity of at least 0.1 W/mK. In one embodiment, the substantially uniform water-resistant material may have a thermal conductivity of about 0.15 W/mK.

In some embodiments, the substantially uniform water-resistant material may have an electrical resistance in the range of 5 E+12 Ωcm to 1.4 E+15 Ωcm. In one embodiment, the substantially uniform water-resistant material may have an electrical resistance of about 6.32 E+13 Ωcm.

In some embodiments, the substantially uniform water-resistant material may have a light transmission efficiency of at least 85% for wavelengths greater than or equal to 380 nm.

In some embodiments, the at least one light source may be a plurality of light sources, the at least one direct volume may be a plurality of direct volumes, such that, for each light source within the plurality of light sources, the plurality of direct volumes may have a corresponding direct volume extending from that light source to the external lens and containing the silicone gel. The at least one reflective surface may be a plurality of reflective surfaces, such that, for each light source within the plurality of light sources, the plurality of reflective surfaces may have a corresponding reflective surface. The at least one reflected volume may be a plurality of reflected volumes, such that, for each light source within the plurality of light sources, the plurality of reflected volumes may have a corresponding reflected volume extending from the corresponding reflective surface for that light source to the external lens.

In an alternative embodiment, there may be fountain system that has a nozzle defining a flow direction for projecting a liquid out of the nozzle, and the water resistant lighting device as described above. The external lens, the at least one light source, and the at least one reflective surface may be oriented to substantially collimate light emitted from the external lens.

In some embodiments, the fountain system may contain the water resistant lighting device such that light emitted from the external lens may be oriented and positioned to illuminate the liquid flowing from the nozzle.

In some embodiments, the water resistant lighting device may have the at least one reflected volume overlap with the at least one direct volume.

### BRIEF DESCRIPTION OF THE DRAWINGS

The person skilled in the art will understand that the drawings, described below, are for illustration purposes only. The drawings are not intended to limit the scope of the applicants' teachings in any way.

FIG. 1 illustrates a perspective view of a water resistant lighting device in accordance with an embodiment of the invention.

FIG. 2 illustrates a sectional side view of the water resistant lighting device of FIG. 1.

FIG. 3 illustrates a perspective view of reflective surfaces of the water resistant lighting device of FIG. 1.

FIG. 4 illustrates a perspective cut-away view of the reflective surfaces of FIG. 3.

FIG. 5a illustrates a side sectional view of the reflective surfaces of FIG. 3, and details paths that light rays may follow.

FIG. 5b illustrates a side sectional view of the reflective surfaces of FIG. 3, and details volumes through which light may be directed.

FIG. 6 illustrates a perspective sectional view of the water resistant lighting device of FIG. 1.

FIG. 7 illustrates a perspective cut-away view of the water resistant lighting device of FIG. 1.

FIG. 8 illustrates a perspective view of the water resistant lighting device of FIG. 1.

FIG. 9 illustrates a side sectional view of the water resistant lighting device of FIG. 1.

FIG. 10 illustrates a perspective sectional view of the water resistant lighting device of FIG. 1.

FIG. 11 illustrates a perspective sectional view of the water resistant lighting device of FIG. 1.

FIG. 12 illustrates a perspective view of a water resistant lighting device in accordance with another embodiment of the invention.

FIG. 13 illustrates a perspective sectional view of the water resistant lighting device of FIG. 12.

FIG. 14 illustrates a side sectional view of the water resistant lighting device of FIG. 12.

FIG. 15 illustrates a perspective view of the water resistant lighting device of FIG. 12.

FIG. 16 illustrates a perspective sectional view of the water resistant lighting device of FIG. 12.

FIG. 17 illustrates a side sectional view of the water resistant lighting device of FIG. 12.

FIG. 18, in a flow chart, shows a method of manufacturing a water resistant lighting device in accordance with an aspect of an embodiment of the invention.

### DESCRIPTION OF PREFERRED EMBODIMENTS OF THE INVENTION

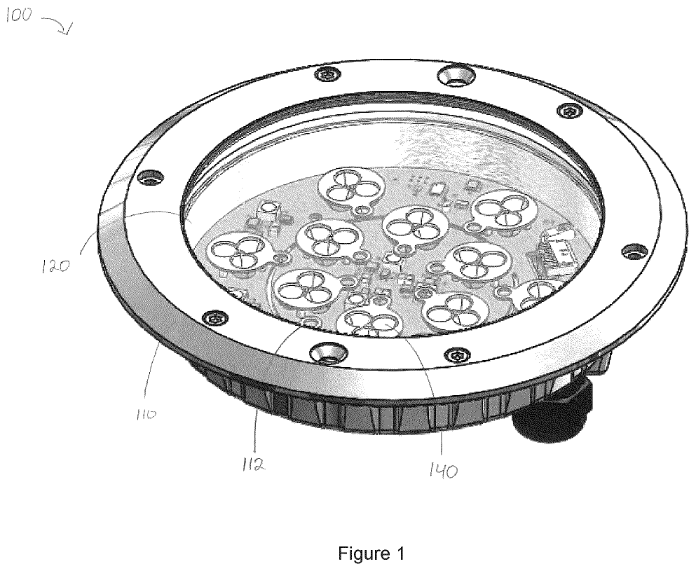

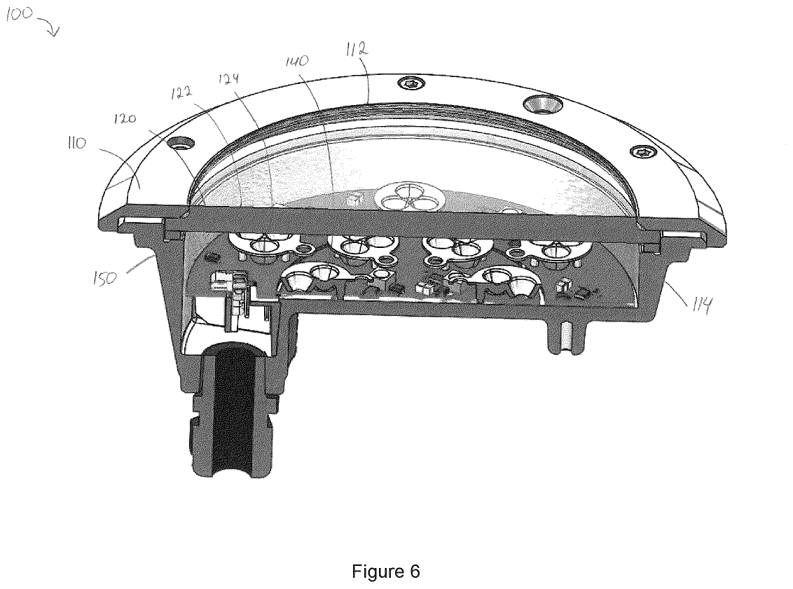

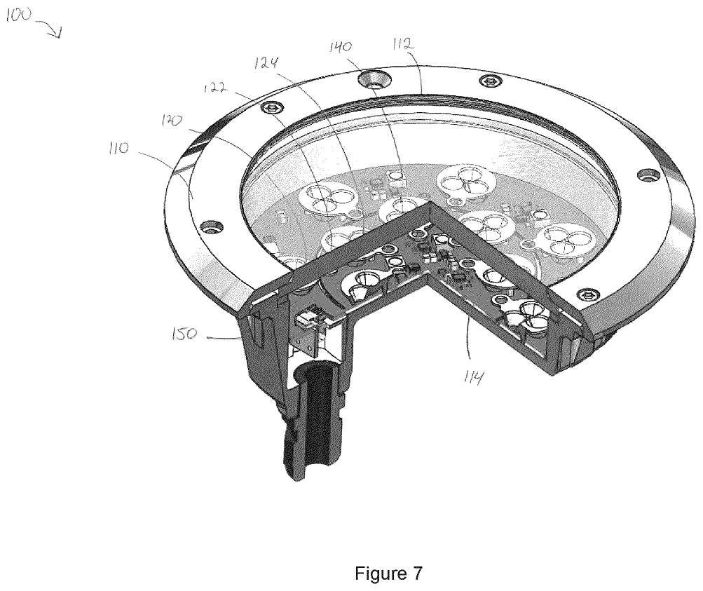

Referring to FIGS. 1-7, there is illustrated a water resistant lighting device 100 in accordance with an embodiment of the present invention. The water resistant lighting device 100 comprises a housing 110 that defines an opening 112. An external lens 120 may cover the opening 112 of the housing 110. The external lens 120 may be attached to the housing 110, and may have an internal surface 124 and an opposing external surface 122. The housing 110 and the internal surface 124 of the external lens 120 define an interior cavity 114 of the housing 110.

The water resistant lighting device 100 comprises at least one light source 130, and, in many embodiments, may comprise a plurality of light sources 130. Each light source 130 may be an LED. Each light source 130 may be mounted within the interior cavity 114 of the housing 110. The light source 130 may be mounted within the interior cavity 114 of the housing 110 by any means known in the art, including, but not limited to: screwing the light source 130 into the housing 110, adhering the light source 130 to the housing 110 with an adhesive, and soldering the light source 130 to the housing 110.

Some of the light emitted from the light source 130 may not be directed at the external lens 120, instead being emitted at an angle relative to a notional line or path 160a extending from the light source 130 to the external lens 120. At least one reflective surface 140 may be provided for reflecting this light received from the light source 130 towards the external lens 120. In many embodiments, the water resistant lighting device 100 may comprise a plurality of reflective surfaces 140. Light that is emitted at an angle relative to the notional line or path extending from the light source 130 to the external lens 120, may contact the reflective surface 140 and be redirected towards the external lens 120 along, for example, notional line or path 170a. The reflective surface 140 may increase the proportion of light from light source 130 that reaches the external lens 120.

A problem with water resistant lighting devices is that corrosion, water pressure, and repeated cycles of thermal expansion and thermal shrinkage can result in water resistant lighting devices developing leaks. At least one water-resistant material 150 can be provided within the interior cavity 114 of the housing 110 to provide or constitute a water barrier 150 for isolating the light source 130 from water. The water barrier 150 may have a proximal surface facing the light source 130, and a distal surface facing the external lens 120. Relative positions and orientations of the external lens 120 and the light source 130 may be substantially fixed, such that much of the light from the light source 130 can be emitted toward the external lens 120.

In some embodiments, the water-resistant material 150 may have a light transmission efficiency of at least 85% for wavelengths greater than or equal to 380 nm.

In some embodiments, the water-resistant material 150 may contain constituents selected from the following materials: urethane, polyurethane, silicon, silicone gel, epoxy, acrylic, and polyester.

In some embodiments, the water-resistant material 150 may contain a solid. In some embodiments, the water-resistant material 150 may contain a gel. The gel may be a silicon gel. Silicon gels are gels that contain the element silicon. For example, the silicon gel may be a silicone gel that is optically clear, with a high light transmission of at least 89% for wavelengths greater than or equal to 380 nm. Silicone gels may also be used at wide temperature ranges, from around −45 degrees Celsius to around 150 degrees Celsius.

Silicone gel may also provide a soft material for use in the water resistant lighting device 100. Soft materials are deformable at low applied stresses, which may reduce mechanical stresses in the water resistant lighting device 100. Due to their easily deformable nature, soft materials may also inhibit notch propagation. That is, a notch that forms in a harder material may propagate and create a crack that damages a larger volume. Soft materials, in contrast, may deform rather than propagate a crack.

In some embodiments, the water-resistant material 150 may be the EG-4131 Dielectric Gel by Dow Corning®. The EG-4131 Dielectric Gel is a silicone gel.

The water-resistant material 150 may also be an epoxy. Epoxy resins can be stable both before and after hardening. Epoxies can provide good thermal resistance of up to around 200 degrees Celsius. Epoxies may also provide good chemical resistance against many substances. Epoxies may be hardened with a wide range of chemicals, including amines, acids, and anhydrides. Epoxies may have high strength and excellent adhesion to metals. Due to their hardness, however, epoxies may be notch sensitive. As described above, notch sensitive materials are materials having a greater likelihood to propagate a crack throughout the material when subjected to sufficient stress. Due to their hardness, epoxies may also provide low adhesion to plastics (such as LEDs and circuit boards) as well as other components (such as some kinds of reflective surfaces) When the plastic bends, the epoxy may be too hard to deform and the bond between the epoxy and the plastic may be broken. Certain strong acids may also damage epoxies. Due to the hardness of epoxy, cycles of thermal expansion and thermal shrinkage may cause damage to electronics (such as LEDs and circuit boards) and other components (such as some kinds of reflective surfaces, that may be deflected by pressure from expanding epoxy) over time, as epoxy may press against these components, instead of readily deforming as a softer material might.

The water-resistant material 150 may also be urethane. Urethane can provide materials with a wide range of hardness: Shore D of 80 to Shore 000 of 50. Urethane may be hardened with an accelerator. The accelerator may be varied depending on the desired hardening speed. Other properties of urethane can be capped substantially constant despite a change in the accelerator used for hardening. Urethane may be used at temperatures in a range of around −40 degrees Celsius to 130 degrees Celsius. Some light sources 130 may reach temperatures that could possibly damage urethane. For example, some urethanes may be damaged if the temperature of the light source 130 exceeds 130 degrees Celsius.

The water-resistant material 150 may also be acrylic. Acrylic can be very fast hardening. Acrylic can have good chemical resistance and can be clear in appearance. While acrylic can be very fast hardening, if the thickness of the mould is too great, the internal portion of the acrylic may not harden sufficiently. In such circumstances, a secondary heat cure or ultra-violet cure may be used to reach the desired hardness and consistency. Due to the hardness of acrylic, and similar to epoxy, cycles of thermal expansion and thermal shrinkage may cause damage to electronics and other components. The optical clarity of acrylic may also deteriorate over time, as the initially clear acrylic may begin to yellow, reducing light transmission efficiency.

Polyester can provide a water-resistant material 150 with good chemical resistance. Polyester can be clear in appearance. Due to the hardness of polyester, however, similar to epoxy, cycles of thermal expansion and thermal shrinkage may cause damage to electronics and other components. Further, cycles of thermal expansion and thermal shrinkage may cause cracking in the polyester. Similar to acrylic, the optical clarity of polyester may also deteriorate over time, as the initially clear polyester may begin to yellow.

In some embodiments, the water-resistant material 150 may be substantially uniform. The substantially uniform water-resistant material 150 may have a thermal conductivity of at least 0.1 W/mK. The substantially uniform water-resistant material 150 may have a thermal conductivity of 0.15 W/mK. By comparison, the thermal conductivity of air at 20 degrees Celsius is about 0.025 W/mK.

Due to the higher thermal conductivity of the substantially uniform water-resistant material 150, heat produced by the light source 130 may be dissipated from the water resistant lighting device 100 at a faster rate than if the water resistant lighting device 100 contained air. By increasing heat dissipation, the thermal strain and thermal stress on the water resistant lighting device 100 can be reduced.

The substantially uniform water-resistant material 150 may be a soft material, such as the above-described silicone gel. Softer materials deform at lower applied stresses. Since the substantially uniform water-resistant material 150 may deform easily, the mechanical stresses in the water resistant lighting device 100 may be reduced.

In some embodiments, the water-resistant material 150 may have an electrical resistance in the range of 5 E+12 Ωcm to 1.4 E+15 Ωcm. In a further embodiment, the water-resistant material may have an electrical resistance of approximately 6.32 E+13 Ωcm.

In some embodiments, the external lens 120 may cover the opening 112 of the housing 110 and may be attached to the distal surface of the water barrier 150. The external lens 120 may be movable relative to the housing 110. For example, the external lens 120 may rest on or be attached to the water-resistant material 150. Allowing relative motion between the external lens 120 and the housing 110, can reduce stress, and may protect the external lens 120 from cracking. Such cracking can happen, for example, due to repeated cycles of thermal expansion and thermal shrinkage—permitting the external lens 120 ride on the water-resistant material 150 can better accommodate this cyclical expansion and shrinkage.

In some embodiments, the water resistant lighting device 100 may not have a separate housing 110. The water resistant lighting device 100 may have a hardened exterior layer and an inner portion, the hardened exterior layer being harder than the inner portion. The hardened exterior layer may provide a housing for containing the inner portion and the light source 130. The hardened exterior layer may also provide housing for containing other elements listed in previous or subsequent embodiments. The hardened exterior layer may be hardened by some form of curing, say by heat, exposure to ultraviolet light, or by chemical means (such as exposure to an acid). In some embodiments, the hardened exterior layer may be made of the water-resistant material 150. In other embodiments, the hardened exterior layer may be made of a material other than the water-resistant material 150, and may, or may not, be water resistant itself.

In some embodiments, the inner portion may comprise the water barrier 150. It may be desirable for some embodiments that at least those portions of the water-resistant material 150 that are in contact with the light source 130, for example, remain soft to better protect these components. For example, if the light source 130 comprises an LED, and other components of the water resistant lighting device 100 include an LED circuit board, and, in some embodiments, reflective surface 140, then it may be desirable that a soft material be provided adjacent these components both to impede leakage of water, and to reduce the risk of damage resulting from the water-resistant material 150 coming into contact with these components.

In some embodiments, the inner portion may comprise the water barrier 150 and an additional material or materials to fill a substantial amount of the interior cavity 114, or the cavity between the inner portion and the hardened exterior layer. For example, the inner portion may contain or comprise silicone gel. Silicone gel, as described previously, may be a soft material that can protect the electronics in the water resistant lighting device 100. In some embodiments, the inner portion may contain silicone gel for those portions of the water-resistant material 150 that are in contact with the light source 130. The additional material may be used to fill the remainder of the inner portion such that the interior cavity of the water resistant lighting device is substantially filled. The additional material may contain constituents selected from the following materials: urethane, polyurethane, silicon, silicone gel, epoxy, acrylic, and polyester.

The hardened exterior layer may, for example, be made of one or more of epoxy, acrylic, urethane, and polyester. While these materials may cause damage to electronics over time due to their hard nature, this damage may be reduced or prevented by spacing these materials from the electronics. For example, providing a softer material between the hardened exterior layer (the housing) and the electronics may protect the electronics. Acrylic can be very fast hardening, which may make for a good moulding material for the hardened exterior layer as it simplifies manufacture. While acrylic may lose optical clarity over time and yellow, by providing a housing for a softer material, the path of light from the light source to the external lens may not be affected by any loss in clarity, as the direct and reflected volumes spacing each light source from the external lens may not include any acrylic.

To achieve the hardened exterior, any suitable technology or method known in the art may be used. Hardening methods may include, but are not limited to, ultra violet light exposure, age hardening, chemical hardening through exposure to a hardening agent, oxidation, and thermal treatment.

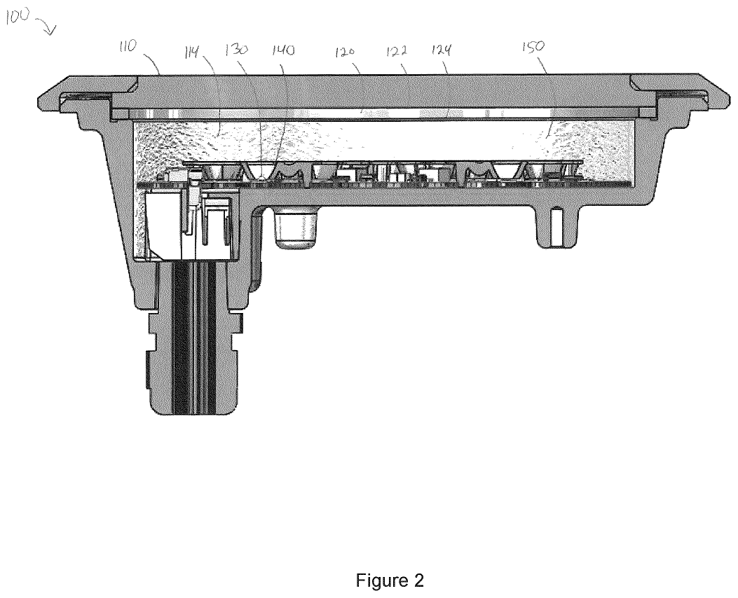

FIG. 1 shows a plurality of reflective surfaces 140 mounted within the interior cavity 114 of the housing 110. Each reflective surface 140 may surround a corresponding light source 130. For example, FIG. 2 illustrates one light source 130 surrounded by the reflective surface 140. The light source 130 may extend from the base of the reflective surface 140 towards the external lens 120. The reflective surface 140 may reflect light emitted from the light source 130 towards the external lens 120. The light source 130 may directly emit at least some light towards the external lens 120 without reflection by the reflective surface 140.

The reflective surface 140 may have an expanding shape, where the reflective surface 140 may be narrowest at the point closest to the light source 130, and widest at the point furthest from the light source 130. This expanding shape may allow for improved reflection of light from the light source 130 towards external lens 120 after reflection off of the reflective surface 140. Optionally, the reflective surface 140 may be mounted on the housing 110.

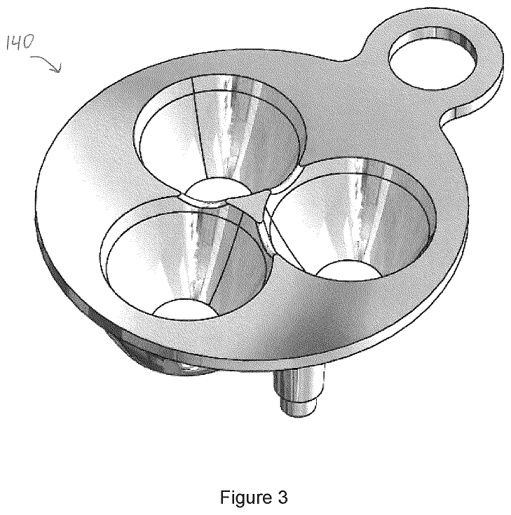

Referring to FIG. 3, there is illustrated, in a perspective view, three reflective surfaces 140. A light source 130 (not shown) may be disposed at the base of each reflective surface 140.

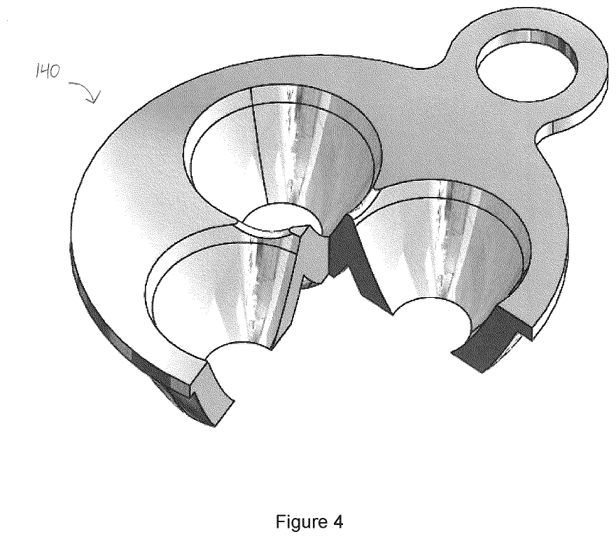

Referring to FIG. 4, there is illustrated, in a perspective cut-away view, three reflective surfaces 140. The light source 130 (not shown) may be disposed at the base of the reflective surface 140.

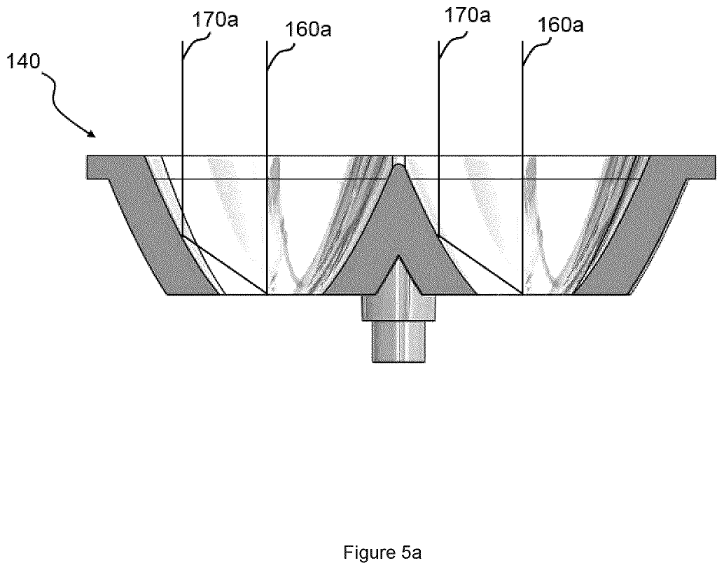

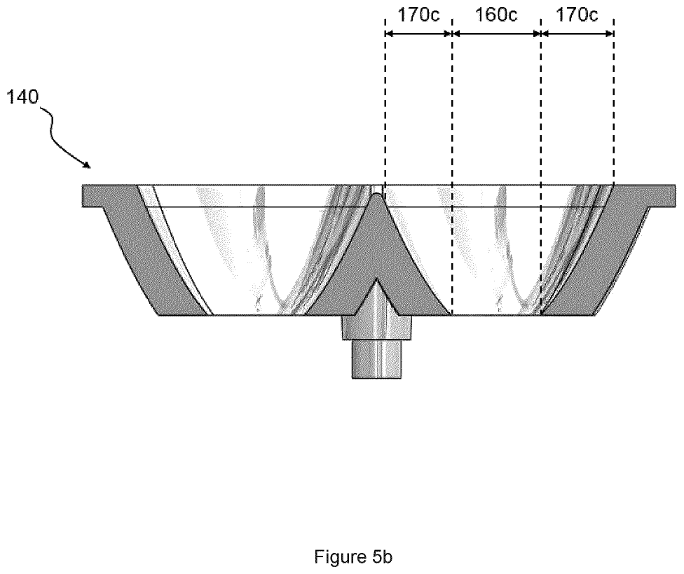

Referring to FIGS. 5a and 5b, there is illustrated, in a side sectional view, two reflective surfaces 140. The light source 130 (not shown) may be disposed at the base of the reflective surface 140. Light projected from the light source 130 toward the external lens 120 passes through the water barrier 150 and passes through at least one direct volume 160c. The direct volume 160c may extend from the light source 130 to the external lens 120. The direct volume 160c may be occupied mostly by the water barrier 150 such that the water barrier 150 impedes leakage of water adjacent the distal surface of the water barrier 150 to the light source 130. The water barrier 150 may also transmit the light projected from the light source 130 to the external lens 120.

Light reflected along path 170a from the reflective surface 140 toward the external lens 120 may pass through at least one reflected volume 170c. The water barrier 150 may impede the leakage of water adjacent the distal surface of the water barrier 150 to the reflective surface 140. The position and orientation of the reflective surface 140 may be substantially fixed relative to the positions and orientations of the external lens 120 and the light source 130. The reflected volume 170c may extend from the reflective surface 140 to the external lens 120 and intersect with the water barrier 150 such that the water barrier 150 may occupy most of the reflected volume 170c and impede leakage of water adjacent the distal surface of the water barrier 150 to the reflective surface 140. Light reflected from the reflective surface 140 may be transmitted through the reflective volume 170c from the reflective surface 140 to the external lens 120, passing through the water barrier 150.

In some embodiments, the reflected volume 170c may overlap the direct volume 160c.

In some embodiments, the water-resistant material 150 may extend substantially through all of the direct volume 160c. The water-resistant material 150 may also extend substantially through the reflected volume 170c.

The substantially uniform water-resistant material 150 may have a direct volume 160c refractive index. The direct volume 160c refractive index may be substantially constant throughout the direct volume 160c. This could, for example, be provided for each direct volume 160c by providing one or more than one water-resistant material 150 throughout the direct volume, such that substantially the entire direct volume 160c is occupied by the at least one water-resistant material 150. If more than one water-resistant material 150 is included within the direct volume 160c, then these water-resistant materials 150 could be selected to have substantially the same refractive indices, varying by less than 5%.

The substantially uniform water-resistant material 150 may have a reflected volume 170c refractive index. The reflected volume 170c refractive index may be substantially constant throughout the reflected volume 170c. This could, for example, be provided for each reflected volume 170c by providing one or more than one water-resistant material 150 throughout the reflected volume 170c, such that substantially the entire reflected volume 170c is occupied by the at least one water-resistant material 150. If more than one water-resistant material 150 is included within the reflected volume 170c, then these water-resistant materials 150 could be selected to have substantially the same refractive indices, varying by less than 5%. The reflected volume 170c refractive index and the direct volume 160c refractive index may be substantially equal.

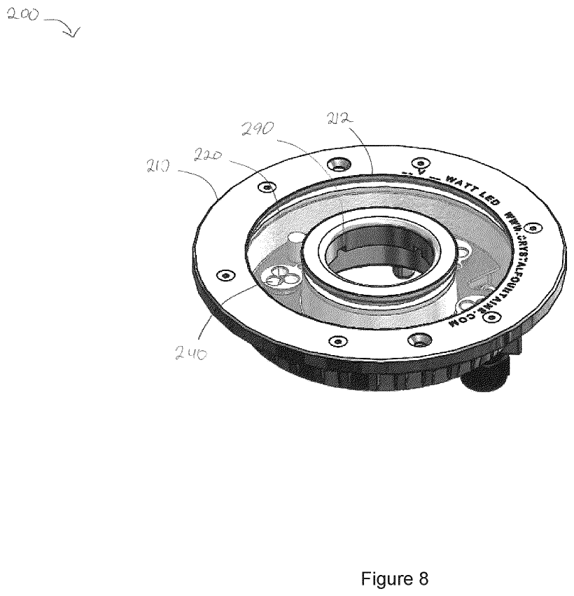

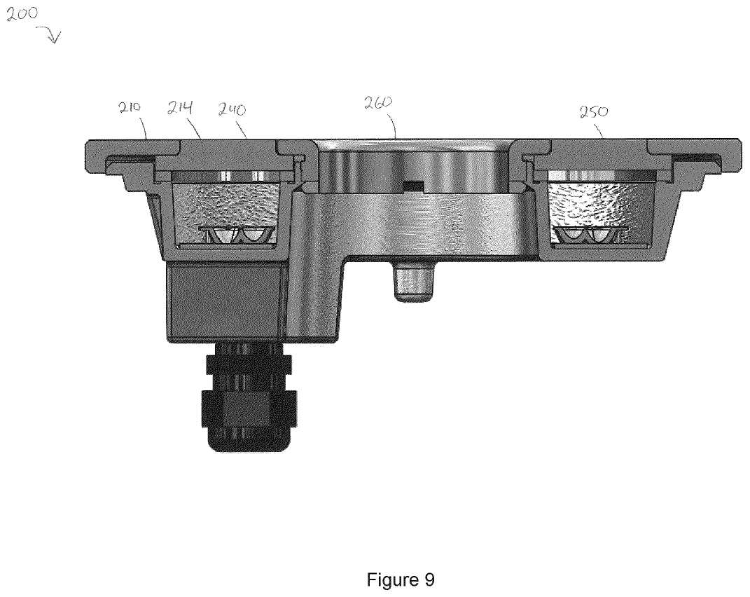

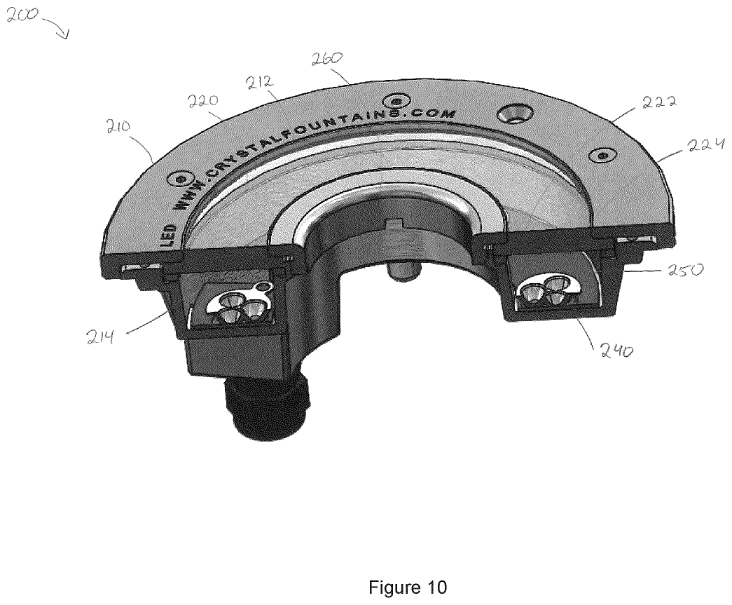

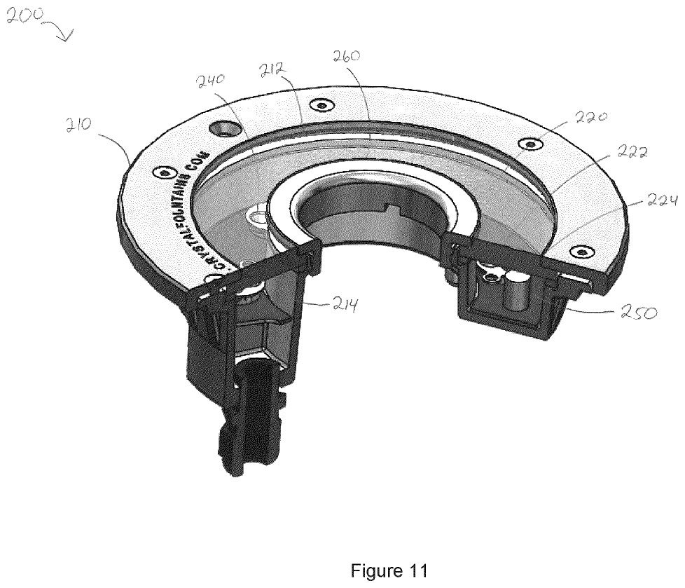

Referring to FIGS. 8-11, there is illustrated an alternate embodiment water resistant lighting device 200. The previous elements for the water resistant lighting device 100 remain generally the same, but the reference numerals designating these elements have been incremented by 100 for the alternative embodiment 200.

As shown in FIGS. 8-11, the water resistant lighting device 200 may have a housing 210 with an aperture 290. The aperture 290 may extend through the entire housing 210. As shown in FIG. 8, the external lens 220 may be altered from its previous embodiment to accommodate the aperture 290. The aperture 290 may be used to allow for transmission of fluid (water, for example) through the water resistant lighting device 200. For example, water resistant lighting device 200 may be aligned with a fountain nozzle to allow for fluid to flow through the aperture 290. The fountain flow may be illuminated by water resistant lighting device 200.

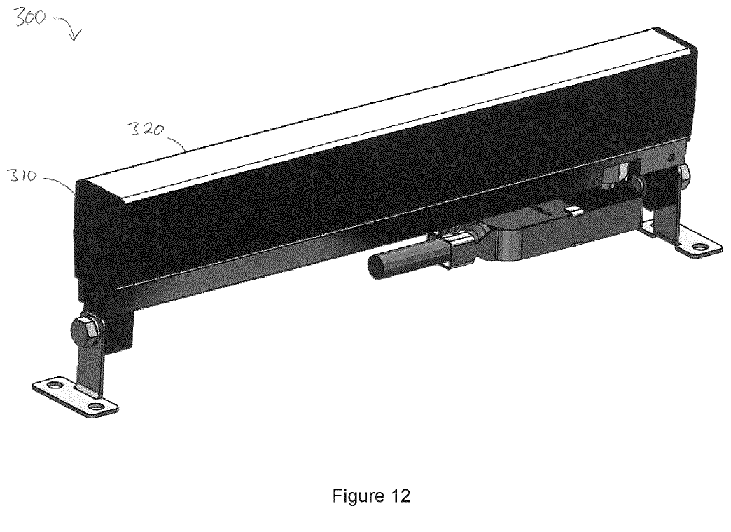

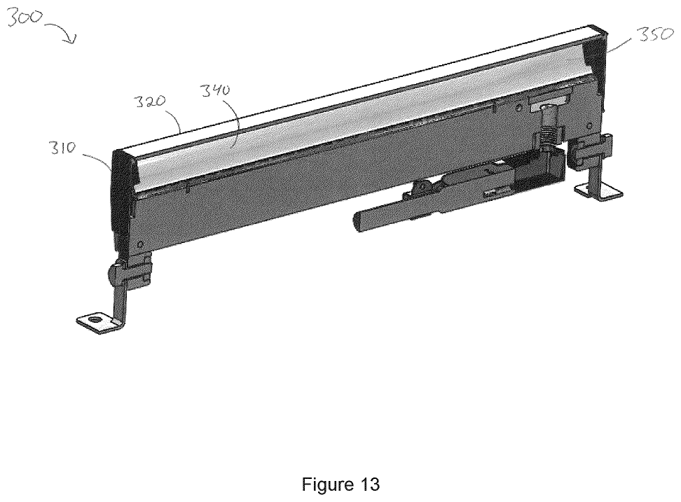

Referring to FIGS. 12-14, there is illustrated an alternate embodiment water resistant lighting device 300. The previous elements for the water resistant lighting device 100 remain generally the same, but the reference numerals designating these elements have been incremented by 200 for the alternative embodiment 300.

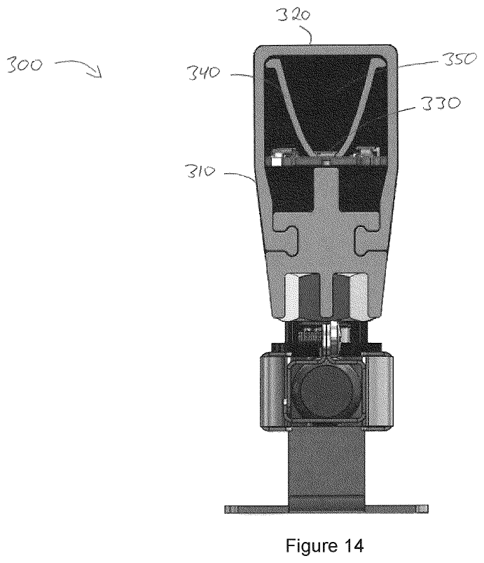

The water resistant lighting device 300 may have a housing 310 that may be elongated. FIG. 14 provides a sectional view across the width of this elongated housing. The housing 310 may contain at least one reflective surface 340. The reflective surface 340 may extend along a substantial length of housing 310. The water resistant lighting device 300 may contain at least one light source 330. In many embodiments, the water resistant lighting device 300 may contain a plurality of the light source 330. The plurality of the light source 330 may extend along the base of the reflective surface 340.

In the side sectional view of the water resistant lighting device 300 of FIG. 14, the water resistant lighting device 300 contains the reflective surface 340 that may extend a substantial length along housing 310.

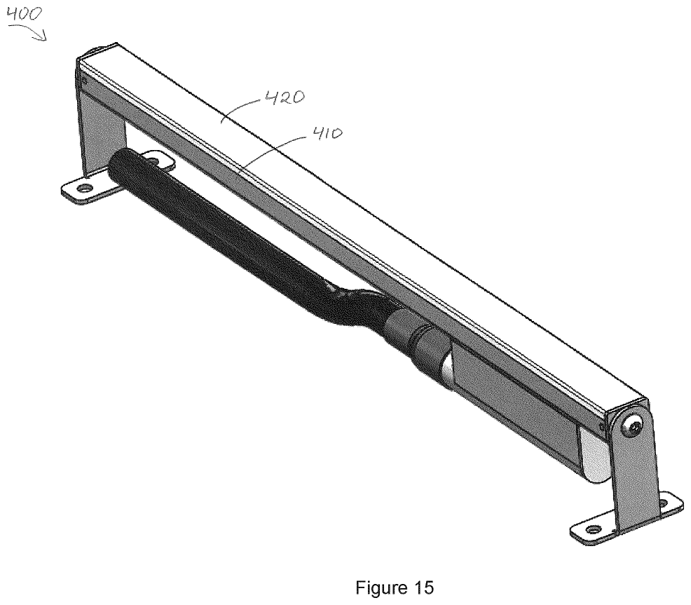

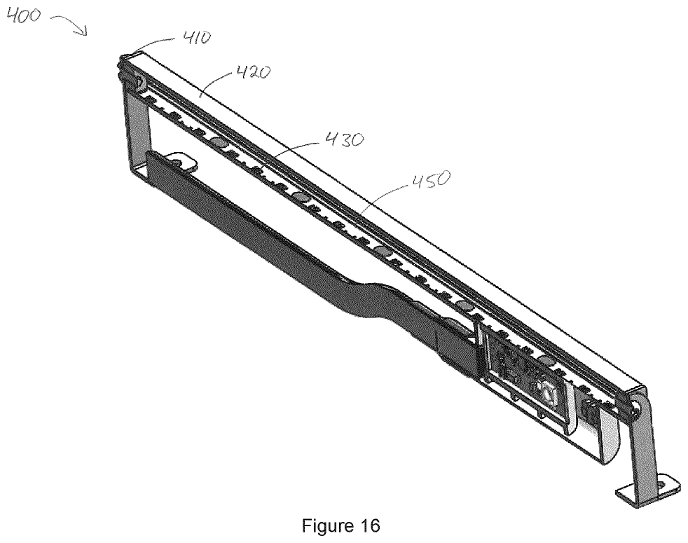

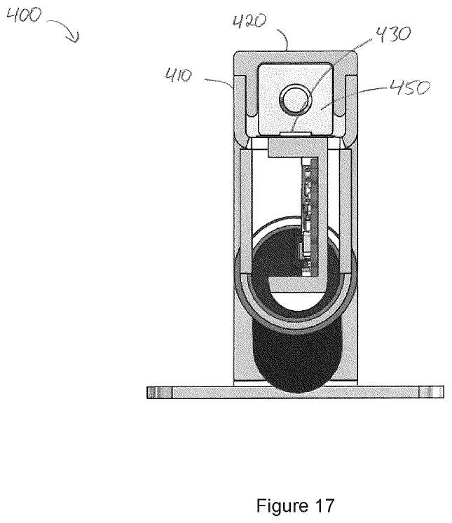

Referring to FIGS. 15-17, there is illustrated an alternate embodiment water resistant lighting device 400. The previous elements for the water resistant lighting device 100 remain generally the same, but the reference numerals designating these elements have been incremented by 300 for the alternative embodiment 400. The water resistant lighting device 400 may have a housing 410 that may be elongated.

The water resistant lighting device 400 contains at least one light source 430. The water resistant lighting device 400 does not contain a reflective surface as may be found in previous embodiments. The lack of a reflective surface may allow the water resistant lighting device 400 to emit light that may be less directional than previous embodiments. Less directional emission may allow for broader illumination of an object or surface to be illuminated.

The water resistant lighting device 400 contains at least one water-resistant material 450. The water-resistant material 450 may be a soft material, as described in previous embodiments. The water-resistant material 450 may be a gel. The water-resistant material 450 may be a silicone gel.

In some embodiments, the water resistant lighting device 100 may contain a thermally-conductive heat sink for conducting heat away from the light source 130. In embodiments that contain both at least one light source 130 and at least one reflective surface 140, the thermally-conductive heat sink may conduct heat away from both the light source 130 and the reflective surface 140.

The thermally conductive heat sink may help to reduce thermal stress and thermal strain in the water resistant lighting device 100. The light source 130, for example, may generate a significant amount of heat. By allowing heat to dissipate from the light source 130 and the reflective surface 140, the water-resistant material 150 may be less affected by thermal stress and thermal strain. Since the water resistant lighting device 100 may be surrounded by or exposed to water, the thermally conductive heat sink may conduct heat from the light source 130 to the surrounding water. Exposing the water resistant lighting device 100 to water may improve the heat dissipation of the thermally conductive heat sink. Reduction in thermal stress and thermal strain may help to increase the useful lifetime of the water resistant lighting device 100.

In some embodiments, the water resistant lighting device 100 may be installed in above water environments, wherein the water resistant lighting device 100 is usually not submerged in, or substantially exposed to water. Non-submerged installations may include bridges, roads, rivers and other infrastructure installations, and landscaping installations such as tree lighting, path lighting, and outdoor building lighting or any other installed lighting application wherein the light is generally not below water.

Water resistant lighting device 100 can provide additional advantages in non-submerged use cases over current dry application lighting devices. Water resistant lighting device 100 can provide substantial protection in the event of unforeseen events, such as heavy rain (especially when accompanied by high winds), flooding, extreme humidity, significant temperature variations (or other environmental conditions or incidents that may compromise the integrity of the external housing or external lens of the light) accidents, such as beverage spills or other incidents in which the water resistant lighting device may be temporarily or unexpectedly exposed to large amounts of water. Dry application lighting may be partially water resistant, but may not withstand the same level of water exposure as water resistant lighting device 100 while remaining operational.

In non-submerged use cases, water resistant lighting device 100 may provide further structural advantages. In the event of an impact that damages external lens 120, substantially uniform water-resistant material 150 can provide secondary protection to components contained within housing 110. Water-resistant material 150 can provide a second physical barrier to protect components such as light source 130 and reflective surface 140 that may be susceptible to damage from water exposure. Even if this second physical barrier protects these components only temporarily, this may give enough time for external lens 120 to be serviced or replaced.

In non-submerged use cases, water resistant lighting device 100 may provide similar thermal advantages over dry application lighting devices, as when installed in a submerged configuration. Due to the higher thermal conductivity of the substantially uniform water-resistant material 150, heat produced by the light source 130 may be dissipated from the water resistant lighting device 100 at a faster rate than if the water resistant lighting device 100 contained air, as is typical for dry application lighting devices. By increasing heat dissipation, the thermal strain and thermal stress on the water resistant lighting device 100 can be reduced.

In non-submerged use cases, water resistant lighting device 100 may use a substantially less robust housing 110, as the water resistant lighting device 100 will not be submerged underwater for significant periods of time, and therefore, will not be subjected to similar levels of water pressure. The use of a less robust housing 110 may provide cost benefits.

In some embodiments, the water resistant lighting device 100 may be used in a fountain system. The fountain system may contain a nozzle that defines a flow direction for projecting a liquid out of the nozzle. The water resistant lighting device 100 in the fountain system may be oriented to substantially collimate light emitted from the external lens 120. The fountain system may further orient and position the water resistant lighting device to illuminate the liquid flowing from the nozzle.

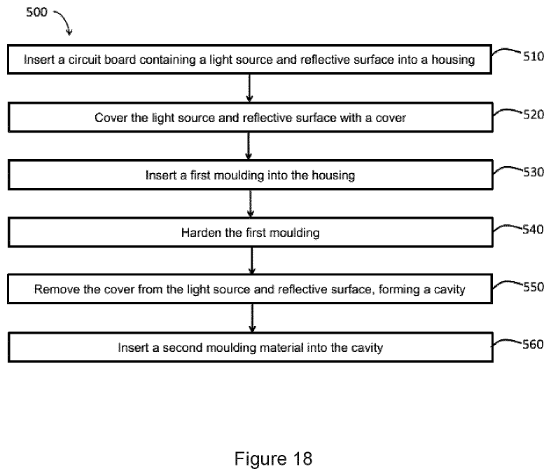

Referring to FIG. 18, there is illustrated in a flow chart a manufacturing process 500. Manufacturing an embodiment of a water resistant lighting device may involve a step 510 of inserting a circuit board containing the light source and the reflective surface into a housing. The circuit board may contain a plurality of light sources and reflective surfaces. In step 520, a covering may be used to cover the light sources and reflective surfaces. Where there is a plurality of the light source and a plurality of the reflective surface, there may be a plurality of coverings including, for example, one for each light source, or, alternatively, one for each light source and its corresponding reflective surface. The covering may extend all, or most of the way, to the opening in the housing in which the external lens is to be located. The covering may be suitably dimensioned and suitably shaped to entirely cover the light source and the reflective surface. For example, the covering may be in the shape of a cylinder or a truncated cone, with radii selected such that the cylinder or truncated cone entirely covers the light source and the reflective surface.

In step 530, a first moulding material may be inserted into the housing and in step 540 the first moulding material may be hardened. The first moulding material may be a gel. The first moulding material may have significantly different properties than the water-resistant material through which light may be transmitted from the light source and the reflective surface to the external lens. For example, the first moulding material may have a different refractive index, may have considerably reduced light transmission efficiency, may be reflective, may be hardenable, and may, after hardening, be much harder than the water-resistant material. If the first moulding material is much harder, or can be hardened, a different covering may be used to cover the entire light source circuit board such that most or all of the circuit board could be shielded from direct contact with the first moulding material.

The cylinder or truncated cone covering the light source and the reflective surface may impede or prevent the first moulding material from intruding between the light source and the reflective surface, and the housing opening, such that the first moulding material would not block light transmitted from the light source and the reflective surface from reaching the housing opening.

After the first moulding material has been inserted into the housing and hardened, in step 550, the covering for the light source and the reflective surface may be removed. More specifically, the cylinder or truncated cones covering the light source and the reflective surface may be removed. Further, if the circuit board was covered for protection when the first moulding material was provided, the circuit board covering may be removed. The removal of the covering would leave behind a cavity (or cavities) into which a second moulding material may then be introduced in step 560. The second moulding material may be a softer, gel-like material that may be easier to insert. The softer second moulding material may be less likely to damage the light source, reflective surface, and the circuit board. The softer second moulding material may also protect these elements from damage due to changes in volume due to, for example, thermal expansion and thermal shrinkage. The softer second moulding material may also be used to cover the circuit board and to occupy the direct and reflected volumes formerly occupied by the cylinders or truncated cones that formerly covered the light source and the reflected surface.

Alternatively, the second moulding material may comprise two or more different second moulding materials. Each of the different second moulding materials may be softer than the first moulding material. Each of the different second moulding materials may also be softer than the circuit board, light sources (LEDs), and reflective surfaces they contact. The second moulding material that covers the circuit board may have different light transmission properties than the second moulding material that covers the light source and the reflective surface. For example, there may be no need for the second moulding material covering the circuit board to transmit any light. In some embodiments, the second moulding material covering the circuit board may be reflective to assist with directing light to the external lens.

In some embodiments, the first moulding material may entirely replace the housing. That is, the first moulding material could be moulded to provide the housing together with the opening into the housing into which the external lens would be subsequently introduced. After the first moulding material had been hardened, the softer second moulding material or different second moulding materials may be introduced into the cavities left by the cylinders, truncated cones, or other coverings.

Various embodiments of lighting devices, fountain systems and methods have been described herein by way of example only. Various modifications and variations may be made to these example embodiments without departing from the spirit and scope of the embodiments, which is limited only by the appended claims which should be given the broadest interpretation consistent with the description as a whole.

1. A water resistant lighting device comprising
an external lens;
at least one light source for directing light toward the external lens;
at least one water-resistant material for isolating the at least one light source from water, the at least one water-resistant material constituting a water barrier for isolating the at least one light source from water, the water barrier having a proximal surface facing the at least one light source, and a distal surface facing the external lens, wherein
relative positions and orientations of the external lens and the at least one light source are substantially fixed,
light projected from the at least one light source toward the external lens passes through the water barrier and at least one direct volume extending from the at least one light source to the external lens and intersecting with the water barrier, such that the water barrier impedes leakage of water adjacent the distal surface to the at least one light source, occupies most of the at least one direct volume, and transmits the light projected from the at least one light source to the external lens;
at least one reflective surface for reflecting light from the at least one light source toward the external lens, wherein
the water barrier impedes leakage of water adjacent the distal surface to the at least one reflective surface,
the position and orientation of the at least one reflective surface is substantially fixed relative to the positions and orientations of the external lens and
the at least one light source, and
light reflected from the at least one reflective surface toward the external lens passes through at least one reflected volume extending from the at least one reflective surface to the external lens and intersecting with the water barrier such that the water barrier occupies most of the at least one reflected volume, impedes leakage of water adjacent the distal surface to the at least one reflective surface, and transmits the light reflected from the at least one reflective surface to the external lens.

2. The water resistant lighting device as defined in claim 1, further comprising a hardened exterior layer, wherein the hardened exterior layer is harder than the water barrier, and provides a housing for containing the water barrier and the at least one light source.

3. The water resistant lighting device as defined in claim 2, wherein the hardened exterior layer is made of the at least one water-resistant material.

4. The water resistant lighting device as defined in claim 3, wherein the at least one water-resistant material comprises a softer water-resistant material and a harder water-resistant material, the hardened exterior layer being formed of the harder water-resistant material, and the water barrier being formed of the softer water-resistant material.

5. The water resistant lighting device as defined in claim 1, further comprising a thermally-conductive heat sink for conducting heat from the at least one light source, the thermally conductive heat sink extending through the at least one water-resistant material.

6. The water resistant lighting device as defined in claim 1, further comprising a housing defining an opening, wherein the external lens covers the opening of the housing, the external lens having an internal surface and an opposing external surface, wherein the housing and the internal surface of the external lens define an interior cavity of the housing and the at least one light source is mounted within the interior cavity of the housing, the at least one water-resistant material being provided within the interior cavity.

7. The water resistant lighting device as defined in claim 6, wherein the external lens is attached to the distal surface of the water barrier, and is movable relative to the housing.

8. The water resistant lighting device as defined in claim 1, wherein the at least one water-resistant material comprises a solid.

9. The water resistant lighting device as defined in claim 1 wherein the at least one water-resistant material is a gel.

10. The water resistant lighting device as defined in claim 1, wherein the at least one water-resistant material comprises at least one constituent selected from the group comprising urethane, polyurethane, silicon, epoxy and polyester.

11. The water resistant lighting device as defined in claim 9, wherein the gel is a silicone gel.

12. The water resistant lighting device as defined in claim 1, wherein a direct volume refractive index is substantially constant throughout the at least one direct volume.

13. The water resistant lighting device as defined in claim 8, wherein a reflected volume refractive index is substantially constant throughout the at least one reflected volume.

14. The water resistant lighting device as defined in claim 1, wherein
the at least one water-resistant material extends through most of the at least one direct volume, and
the at least one water-resistant material extends through most of the at least one reflected volume.

15. The water resistant lighting device as defined in claim 14, wherein
the at least one water-resistant material is a substantially uniform water-resistant material,
a direct volume refractive index is substantially constant throughout the at least one direct volume,
a reflected volume refractive index is substantially constant throughout the at least one reflected volume, and
the reflected volume refractive index and the direct volume refractive index are substantially equal.

16. The water resistant lighting device as defined in claim 15, wherein the substantially uniform water-resistant material has a thermal conductivity of at least 0.1 W/mK.

17. The water resistant lighting device as defined in claim 15, wherein the substantially uniform water-resistant material has an electrical resistance in the range of 5 E+12 Ωcm to 1.4 E+15 Ωcm.

18. The water resistant lighting device as defined in claim 17, wherein the substantially uniform water-resistant material has a light transmission efficiency of at least 85% for wavelengths greater than or equal to 380 nm.

19. The water resistant lighting device as defined in claim 11, wherein
the at least one light source comprises a plurality of light sources,
the at least one direct volume comprises a plurality of direct volumes, such that, for each light source within the plurality of light sources, the plurality of direct volumes comprises a corresponding direct volume extending from that light source to the external lens and comprising the silicon gel;
the at least one reflective surface comprises a plurality of reflective surfaces, such that, for each light source within the plurality of light sources, the plurality of reflective surfaces comprises a corresponding reflective surface;
the at least one reflected volume comprises a plurality of reflected volumes, such that, for each light source within the plurality of light sources, the plurality of reflected volumes comprises a corresponding reflected volume extending from the corresponding reflective surface for that light source to the external lens.

20. A fountain system comprising
a nozzle defining a flow direction for projecting a liquid out of the nozzle, and
a water resistant lighting device as defined in claim 1, wherein the external lens, the at least one light source, and the at least one reflective surface are oriented to substantially collimate light emitted from the external lens.

21. The fountain system as defined in claim 20, wherein the light emitted from the external lens is oriented and positioned to illuminate the liquid flowing from the nozzle.

22. The water resistant lighting device as defined in claim 1, wherein the at least one reflected volume overlaps the at least one direct volume.
